(19) United States
(12) Patent Application Publication
(10) Pub. No.: US 2008/0055887 A1
(43) Pub. Date: Mar. 6, 2008

(54) Helmet visor

(75) Inventor: Norman Tien-Hou Cheng, Kowloon (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: STRATEGIC SPORTS LTD., Kowloon (CN)

(21) Appl. No.: 11/512,571

(22) Filed: Aug. 30, 2006

(51) Int. Cl. F21V 21/084

(52) U.S. Cl. 362/105

(57) ABSTRACT

A detachable visor for a helmet incorporates an integrated light unit. The light unit may be detachable. A smooth design is facilitated, and which is particularly suitable for cycle helmets.

### TECHNICAL FIELD

This invention relates to a helmet visor particularly though not exclusively for a cycle helmet. The visor incorporates a self-contained light fitting.

### BACKGROUND TO THE INVENTION

Safety helmets are used in many kinds of business and leisure. A particular difficulty with helmets is to affix a suitable light source, either to identify the presence of the wearer, or to spread light to permit the wearer to operate in the dark. Prior light sources tend to be stand alone lamps which are tied or otherwise affixed to helmets—this kind of fixing is imprecise and the lamp may wobble. Furthermore, such lamps tend to sit on a helmet as an upward protuberance, and are thus vulnerable to contact damage with low ceilings and the like.

Particularly in the case of cycle helmets, upstanding lamps are an impediment to smooth air flow.

What is required is an improved light source for use with a helmet.

### SUMMARY OF THE INVENTION

According to the invention there is provided a helmet visor, said visor having an integrated light source. In a preferred embodiment the light source is forward facing.

Preferably the visor is attachable to a helmet and detachable from a helmet on demand.

The invention has the advantage that a lamp integrated within a visor need take up no more space than a conventional plain visor. Furthermore the user may switch from the invention to a plain visor on demand and vice versa. Yet another advantage is that a malfunctioning visor may be replaced as a unit. Moreover a user may switch from a visor incorporating an identification lamp to one providing illumination for working, as desired. The visor of the invention is preferably of a relatively soft flexible plastics material.

Preferably the visor incorporates a removable lamp unit, so as to facilitate replacement and/or repair. Furthermore the visor may incorporate a removable power pack, for example one or more rechargeable batteries. Alternatively the power pack may be integrated with the visor and have a recharging socket, or recharging leads, or be operable with regular batteries. Alternatively the lamp may include a built-in power supply of any suitable kind.

In the case of a removable lamp unit, the visor may include a slot, and the lamp unit may include a leg engageable in the slot. Such an arrangement permits the lamp unit to slide into place and be retained against movement other than in the installation/removal direction. In one embodiment, the slot extends generally rearwardly, and the leg of the lamp unit has an enlarged foot at the underside.

Preferably the lamp unit/visor incorporates a snap-fitting retention latch to retain the lamp unit in the correct position and/or orientation. Other means of locating and/or attaching the lamp unit are possible, and all such means are intended to fall within the scope of the invention. The lamp unit may be attached to the side or to the underside of the visor.

The light source of the visor may be arranged additionally or alternatively to emit light to one or both sides, and/or upwardly. Where a single light source having different functions is provided, a means of switching between functions may be provided. Multiple light sources may also be switchable on demand. The light source may incorporate a clear or an opaque lens, and may include one or more refractive elements.

In a preferred embodiment the light source comprises one or more light emitting diodes, preferably white LEDs. The light source preferably includes an integrated on/off switch, and may further include a mode switch whereby the source may provide a constant or a flashing light. Furthermore a variator may be provided to vary lamp intensity.

The visor is preferably shaped to engage the front periphery of the helmet in order to improve lateral stability thereof.

In the case of a cycle helmet having ribs, the rear edge of the visor may be serpentine so as to engage in and between said ribs.

### BRIEF DESCRIPTION OF DRAWINGS

Other features of the invention will be apparent from the following description of a preferred embodiment illustrated by way of example only, in the accompanying drawings in which:

FIG. 1 illustrates in side elevation a cycle helmet in use.

FIG. 2 is a front perspective view of a first embodiment of the invention.

FIG. 3 is a front perspective view corresponding to FIG. 1, but absent a light fitting.

FIG. 4 corresponds to FIG. 2 and shows an alternative light fitting.

FIG. 5 corresponds to FIG. 3.

FIG. 6 illustrates (in upturned state) a removable light fitting.

FIG. 7 illustrates from the underside and the rear another alternative embodiment with removable power pack.

FIG. 8 shows the embodiment of FIG. 7 from above and the front.

FIG. 9 illustrates another embodiment from the front and above.

FIG. 10 shows the embodiment of FIG. 9 absent a light fitting.

FIG. 11 illustrates a light fitting for the visor of FIGS. 10 and 11.

FIG. 12 shows a view of yet a further embodiment from the underside, and

FIG. 13 shows the embodiment of FIG. 12 from above and the front.

### DESCRIPTION OF PREFERRED EMBODIMENTS

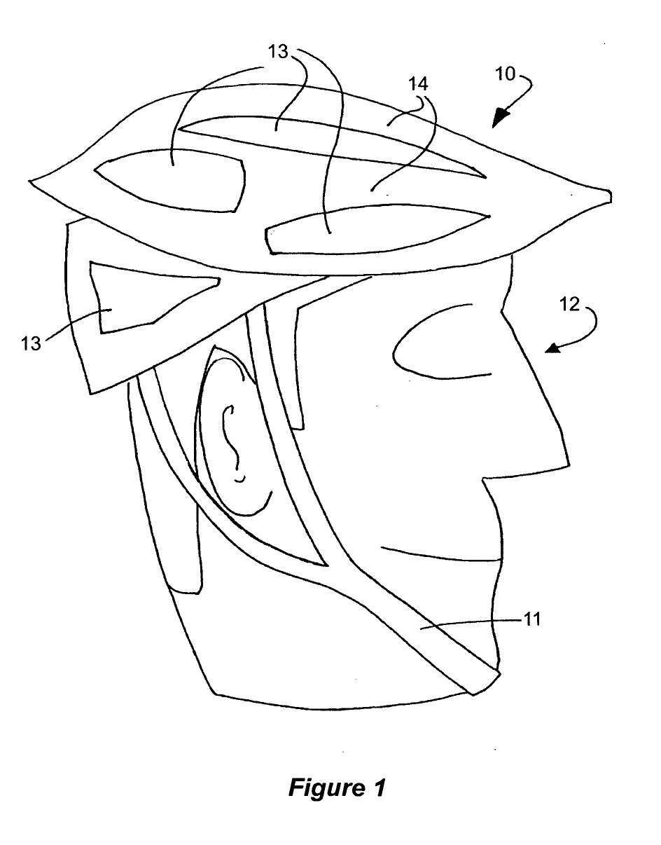

With reference to FIG. 1, a cycle helmet 10 comprises a lightweight composite having a relatively hard outer shell and a soft core. A chin strap 11 is adjustable to retain the helmet in place upon a users head 12. Suitable ventilation openings 13 are defined by ribbing 14 which generally runs from front to back. Various patterns of ribbing and reinforcement may be provided.

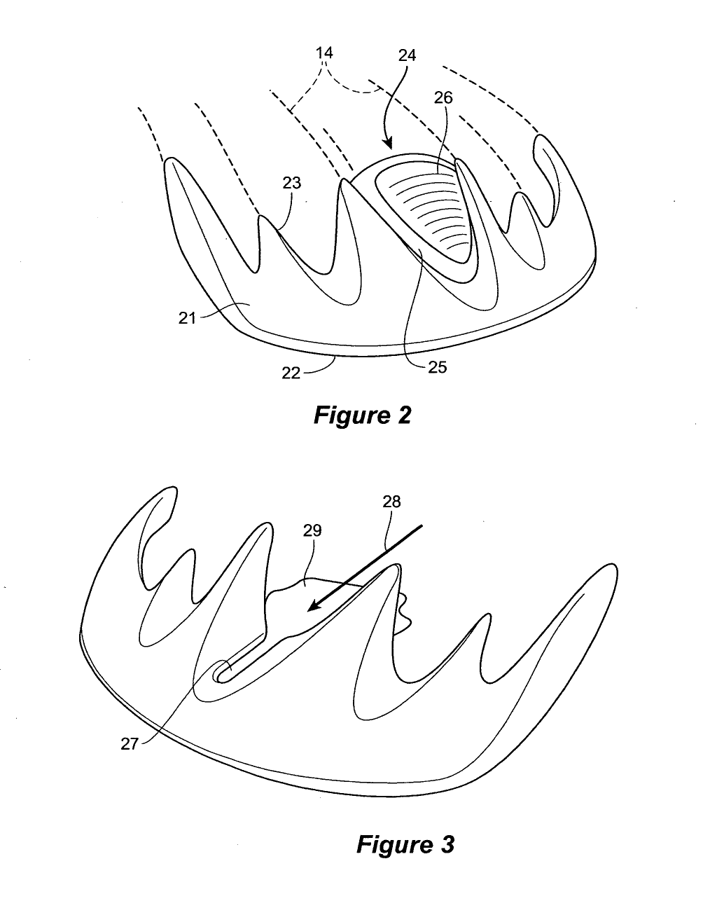

FIGS. 2 and 3 illustrate a first embodiment of a visor 21 adapted for fitting to the front of a helmet of the kind illustrated in FIG. 1. The visor defines a front peak 22 having a smooth arcuate shape, and has a serpentine rear edge 23 adapted to fit in and around the usual helmet ribbing 14 (illustrated by dotted line). The serpentine rear edge may take any suitable form so as to adapt to a desired helmet shape, and may alternatively be a smooth arcuate edge. A serpentine edge is preferred so as to assist in retaining the visor against relative lateral movement. A peg and slot arrangement is a suitable alternative connection to enhance lateral stability.

In the approximate centre, the visor includes a light fitting 24, typically comprising a housing 25, a lens 26, an internal power pack (not shown) and a light source, typically one or more light emitting diodes (LED's).

The visor and light fitting are typically moulded of suitable plastics materials, such as polycarbonates, which are robust, yet unlikely to cause injury in the event of an accident. The skilled man will be able to determine suitable materials from the wide available range. The visor may be a co-moulding comprising a relatively rigid body and soft front lip.

FIG. 3 illustrates the visor of FIG. 1 absent the light fitting. A suitable slot 27 for receiving a post mounting of a light fitting (in the direction of arrow 28) is provided, and a base plate 29. The base plate may comprise a male protrusion for retaining the visor to a helmet by co-operation with a suitably shaped female recess. Other fixing systems may be provided, such as press-studs, hook and loop fasteners, and/or any other means which allows secure retention of the visor in use, and detachability.

The light fitting 24 may be retained by a suitable integral latch, such as a snap-fitting tongue, or be permanently attached by e.g. adhesive or co-moulding. If removable, it will be appreciated that the light fitting is in use trapped between visor and helmet against fore and aft movement.

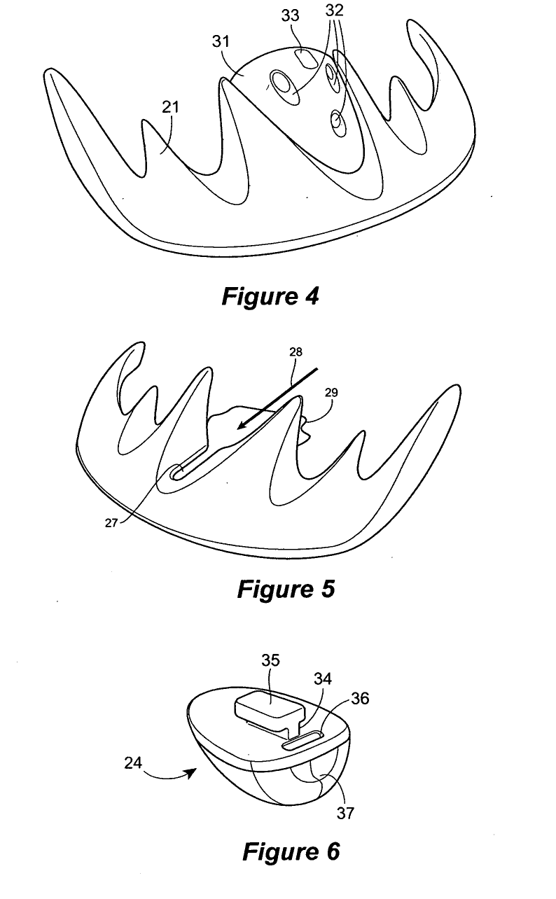

FIG. 4 illustrates a visor 21 having an alternative lens 31 with individual LED's 32. An on/off button 33 is provided at the rear edge.

FIG. 5 corresponds to FIG. 3. FIG. 6 shows a removable light fitting 24 in the upturned state, and illustrating the mounting post 34 having an enlarged foot 35. The post and foot 34, 35 has length so as to prevent arcuate movement of the light fitting when in the slot 27. A latch depression 36 is provided at the rear edge for a snap-fitting latch projection (not shown) of the base plate 29. An opening 37 at the rear edge allows access for a power pack, such as one or more batteries.

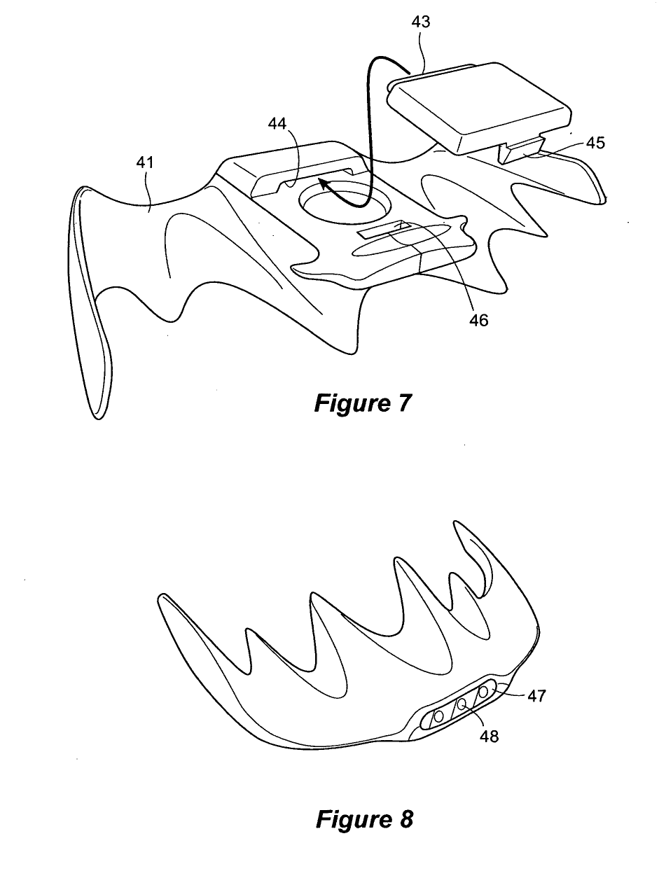

With reference to FIGS. 7 and 8 a visor 41 of the general form previously described, has a removable power pack 42 of generally flat rectangular appearance. The nose 43 of the power pack is reduced in size to fit closely within a suitable recess 44 moulded in and through the visor. An integral latch 45 at the rear edge of the power pack 42 is engageable within a suitable recess 46. The front side of the visor recess 44 may be closed by a lens 47, which may refract or focus light as desired. A clear lens may show suitable LED's 48 therethrough.

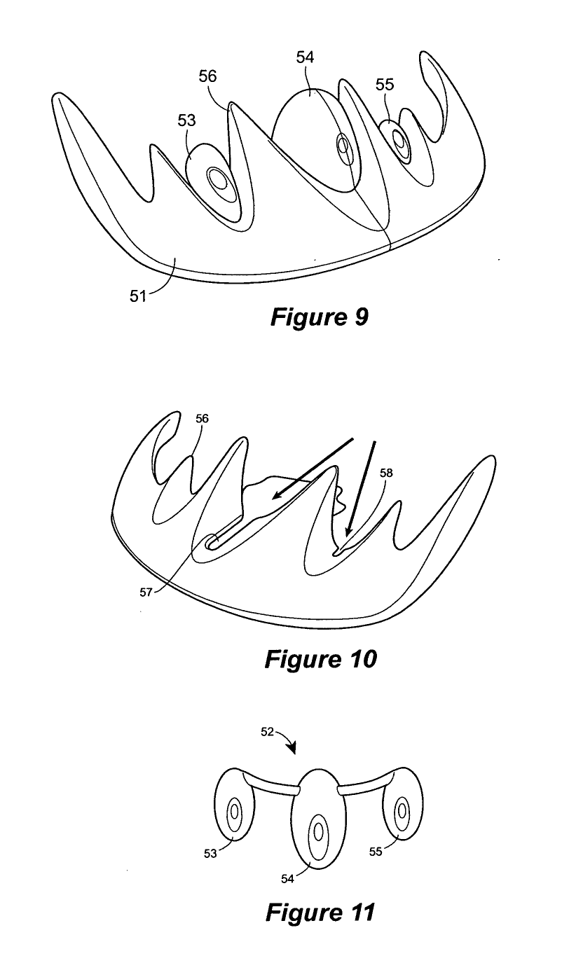

With reference to FIGS. 9-11, a visor 51 includes a multi-component light fitting 52, having three light sources 53, 54, 55 arranged one in each of three adjacent recesses of the serpentine rear edge 56.

The visor includes a main fitting slot 57 of the kind illustrated in FIG. 3, and a minor fitting slot 58 for each of the endmost light sources. The rim or slots 58 comprises merely location fixing recesses, whereas the main fitting slot 57 typically includes a latch.

A suitable light fitting is shown in FIG. 11, and may comprise an LED as each source 53-55, or for example comprise a single light having fibre optic transmission to the individual lenses.

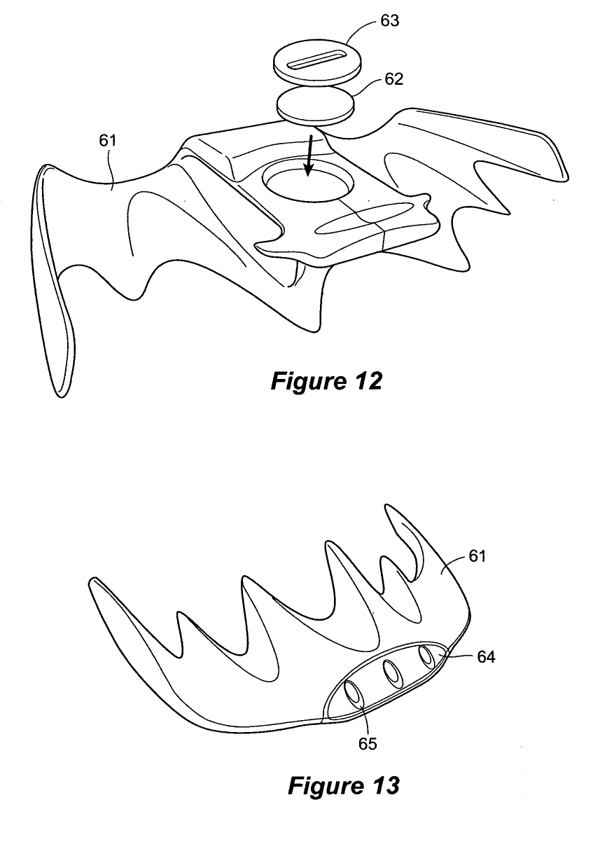

FIGS. 12 and 13 illustrate a visor 61 having an integrated light fitting adapted to receive a disc battery 62 under a removable cover 63. A suitable lens 64, of e.g. clear polycarbonate covers three LED's 65.

The visor of the invention may be mounted or clipped to a helmet in any suitable manner, for example by using one or more male pegs snap-fitting into one or more female recesses. The visor may be removable, or attached in a permanent or semi-permanent manner.

The power pack may be rechargeable, and include a suitable charging socket or charging leads. The lamp unit may include a solar cell for recharging. Any suitable on-off switch may be used, and the lens may comprise a switch button in order to maintain a smooth external appearance.

The light fitting of the invention may be adapted to act at a lower output to identify a helmet wearer in low light conditions, or more preferably at a high output to illuminate the area in front of the helmet for the wearer.

By integrating a light fitting into a visor, weight is minimised. The integrated light fitting also has low wind resistance, which is important in the case of a cycle helmet, and a flush fitting to prevent any upstand which might contact or be damaged as the wearer moves around.

Although this invention has been described in relation to a cycle helmet, it will be appreciated that it is applicable to other kinds of safety helmet on which visors may be required.

1. A helmet visor incorporating an integrated light source.

2. A helmet visor according to claim 1 and including an attachment system for fixing the visor to a helmet.

3. A helmet visor according to claim 1 wherein the visor is detachable from a helmet.

4. A visor according to claim 1 wherein said light source is detachable.

5. A visor according to claim 1 wherein said light source incorporates a retention latch engageable with said visor.

6. A visor according to claim 5 wherein said retention latch comprises a resilient tongue.

7. A visor according to claim 1 and further including a detachable power pack for said light source.

8. A visor according to claim 7 wherein said power pack and light source are integrated.

9. A visor according to claim 4 and defining a rearward facing slot having an axis, said light source including a leg engageable in said slot, and said leg having an enlarged foot.

10. A visor according to claim 1 wherein said light source comprises one or more light emitting diodes.

11. A visor according to claim 1 and incorporating a rechargeable power pack.

12. A visor according to claim 1 and adapted to incorporate one or more dry cell batteries.

13. A visor according to claim 1 and further including a rearwards projecting rear edge to enhance lateral stability thereof.

14. A visor according to claim 13 wherein the rear edge is serpentine and adapted to engage the serpentine form of a helmet.

15. A visor according to claim 1 wherein said attachment system comprises a male rear facing projection adapted for engagement in a female recess of a helmet.

16. A visor according to claim 15 wherein said male projection is adapted for snap fitting.

17. A visor according to claim 1 and further including a helmet attached thereto.

18. A helmet and a visor in combination, said visor being detachable and incorporating an integrated light source.
